(19) United States
(12) Patent Application Publication
(10) Pub. No.: US 2023/0166308 A1
(43) Pub. Date: Jun. 1, 2023

(54) REFINER, INSTALLATION AND METHOD FOR TREATING COMPOSITE PRODUCTS

(71) Applicant: SOPREMA, STRASBOURG (FR)

(72) Inventors: Pierre-Etienne BINDSCHEDLER, STRASBOURG (FR); Patrick BALL, BARR (FR)

(21) Appl. No.: 17/920,364

(22) PCT Filed: Apr. 1, 2021
(86) PCT No.: PCT/EP2021/058738

§ 371 Date: Oct. 20, 2022

(30) Foreign Application Priority Data
Apr. 22, 2020 (FR) 2004002

(51) Int. Cl. B09B 3/40; B09B 3/38; C08L 95/00

(52) U.S. Cl. CPC B09B 3/40; B09B 3/38; C08L 95/00; B09B 2101/75

(57) ABSTRACT

The invention relates to a refiner (1) for treating composite products made from thermoplastic material(s), comprising an enclosure (3) with a cylindrical wall, defining a treatment chamber provided with at least one feed opening (5) for products to be treated and at least one outlet opening (5′) for treated products, and a cylindrical drum (6), mounted so as to be able to move in the cylindrical enclosure (3) and having a diameter smaller than that of the latter, the longitudinal axes of symmetry of the outer enclosure (3) and the inner drum (6) respectively being parallel to each other,

the refiner (1) being characterized in that it comprises a means for heating the treatment chamber (4) and in that the drum (6) is mounted in the outer enclosure (3) so that it is able to move in rotation about its longitudinal axis (A2) and so that its longitudinal axis (A2) is able to move along a circular path around the longitudinal axis of said enclosure (3), the two types of possible movements mentioned above being controlled by separate drive and/or actuation means allowing them to be effected selectively or in combination.

The present invention relates to the field of treating composite products made from thermoplastic material(s), in particular polymeric and/or bituminous material(s), in particular in a context of upgrading and recycling construction and factory waste, and concerns a refiner for treating such products, preferably pretreated, as well as an installation comprising it and a method for controlling such a refiner.

In the context of the general trend to seek, where possible, to upgrade waste, a growing demand, for which no satisfactory solution currently exists either on a technical level or on an economic level, relates to treating factory and, above all, construction waste, in the field of waterproofing buildings and civil engineering structures, in particular in relation to bituminous waterproofing membranes.

The main problem encountered, for which no satisfactory solution currently exists, relates to the presence, often combined with the material to be upgraded (essentially the bituminous binder), of components that cannot be upgraded, in particular hard solid particles of the metal or mineral type or the like (originating from assembling or fastening elements, cover layers, surface protection layers of mineral and fibrous fillers, or similar).

In particular, the deconstruction waste from the renovation market currently represents a major potential source of waterproofing membranes to be treated, currently estimated at approximately 100,000 tons annually in France (estimation by the Chambre Syndicale Française de l'Etanchéité (French waterproofing committee), this source being renewed each year. The cost of sending this waste to landfill has been on the increase for many years, and this trend is set to continue, especially given that no genuine industrial solution for treating deconstruction waste is currently available.

Combined with high pressure on petrochemical raw materials such as bitumen, for example, there is therefore a strong and continuing demand to find an efficient industrial solution to convert the waste mentioned above into raw materials for the production of waterproofing membranes or similar waterproofing products.

Yet the constitution and, therefore, the treatment of this waste is complex, because, during the renovation of building roofs, it is possible, and common practice, to superimpose several layers of membranes on top of each other, and to assemble them by bonding or welding, and to fix them mechanically to the support.

However, after a certain number of renovations (depending on the legislation of the country in question), it is technically necessary and administratively compulsory to remove the entire covering system and install new waterproofing on the roof (pitched roof; flat roof or other) in its unfinished state.

The waste recovered at the end of this total removal operation, referred to as deconstruction waste, essentially comprises layers of bituminous membranes adhered together.

These bituminous membranes, which constitute or contain the products to be upgraded, are generally constituted by a reinforcement (for example, non-woven polyester PNT or surfacing mat, etc.), a bituminous binder (for example, a mixture of bitumen, polymers, additives, fillers, etc.), and a surface finish (for example, slate granules, sand, complexed aluminum sheet, other particulate or granular protective layers, etc.).

Pre-treating (for example, by shearing, heating, grinding, selective extraction, separation, etc.) the composite products formed for the above-mentioned wastes until a hot, viscous semi-liquid product is obtained, free of solid and hard macroscopic contaminants, is known.

However, such a product is not workable/reusable as such and requires at least one additional treatment of the polymers and small particles (typically 20 mm) that it still contains after the pretreatment.

Examples of possible millimetric and submillimetric particles present in the case of composite products originating from bituminous waterproofing products and which demonstrate beneficial properties include: fibers [which also give the matrix mechanical properties (hardness, strength)] and fillers which allow cost optimization. In order for the role played by these particles to be optimal, in the upgraded product, it is necessary for them to be reduced to a microscopic size. Other components which are dissolved in the bituminous binder also need to be worked before the possible reuse of said binder. This applies, for example, to polymers [which give the matrix mechanical properties (elastic or plastic)],

Preferably, these particles, which are present in the pretreated products in centimetric sizes, should be reduced to dimensions=<100 μm.

At least two types of devices are already known which are designed to at least perform the dimensional reduction treatment in question, but each of them has notable limitations.

Thus, colloidal mills (for example of the type known by the trade name Trigonal by the company Siefer) are intended for wet fine grinding of hard and granular materials and allow for intense shearing with a short residence time.

However, this solution is very sensitive to particle dilution rates and, if there are too many particles, the mill risks becoming clogged. Moreover, this solution is not robust for hard particles because they destroy the cutting blades. Finally, if the polymers are too hard, the colloidal mill does not have time to treat them completely, and several mm of (unmelted) residues remain. The blades may wear very quickly depending on the types of raw materials to be treated, and frequent replacement is necessary. As a result, they have a very high operating cost.

As another known solution, continuous filters (for example, see: US 2010/127106 and US 2010/190 893) constitute homogenizing, refining and filtering machines (with several blades that move in a perforated container, scraping the inner wall) and allow moderate shear with a moderate residence time. In such a filter, the polymers are stretched against the wall of the container, which is not specifically heated (in the flow of product). Particles smaller than a mm are not treated (they pass through the holes) and macroscopic (>mm) hard particles settle to the bottom of the container and need to be separated out of the flow of product (separation and production of waste). The fibers are not well treated; many inactive zones in the filter lead to sedimentation of the fibers and partial clogging of the filter after a certain amount of operating time (frequent maintenance).

Therefore, from the point of view of reusing the treated product, it can be objectively concluded that neither of the two known solutions mentioned above allows for the complete treatment of thermoplastic (especially bituminous) composite products containing polymers and solid particles (granules, fibers). The macroscopic (>mm) hard particles are not treated in either of the two solutions. Moreover, the stretching of the polymers is partial, and takes place at a temperature identical to that of the product. The fibers are not treated in a satisfactory manner in either of the two cases.

The essential aim of the present invention is to overcome the disadvantages of the solutions mentioned above.

To this end, it relates to a refiner for treating composite products made from thermoplastic material(s), in particular polymeric and/or bituminous material(s), these products being advantageously pretreated and in viscous form, and containing solid fragmentary and/or particulate elements, of mineral and/or organic nature(s), such as particles or fibers, this refiner comprising an enclosure with a cylindrical wall, defining a treatment chamber provided with at least one feed opening for products to be treated and at least one outlet opening for treated products, and a cylindrical drum, mounted so as to be able to move in the cylindrical enclosure and having a diameter smaller than that of the latter, the longitudinal axes of symmetry of the outer enclosure and the inner drum respectively being parallel to each other, the refiner being characterized in that it comprises a means for heating the treatment chamber and in that the drum is mounted inside the outer enclosure so that it is able to move in rotation about its longitudinal axis and so that its longitudinal axis is able to move along a circular path around the longitudinal axis of said enclosure, the two types of possible movements mentioned above being controlled by separate drive and/or actuation means, allowing them to be effected selectively or in combination.

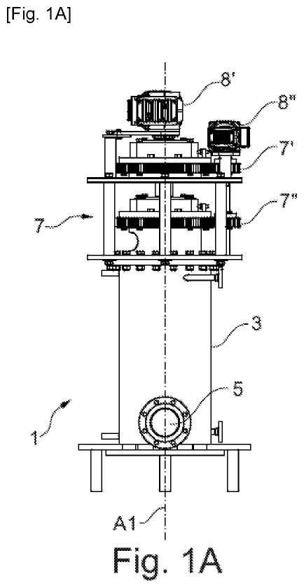

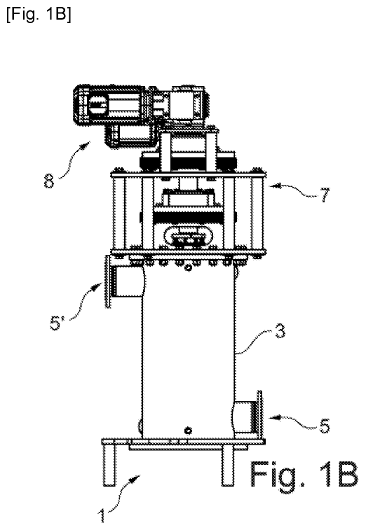

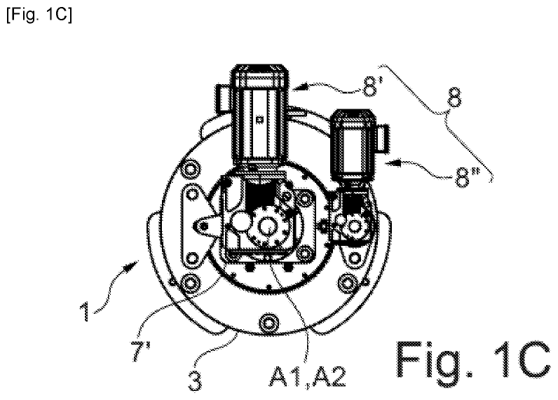

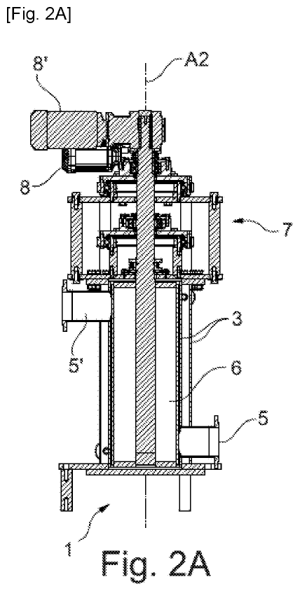

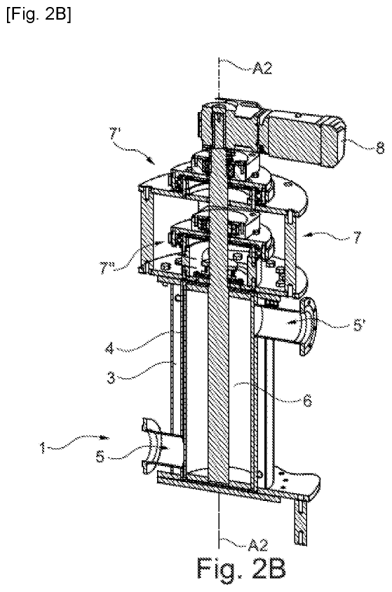

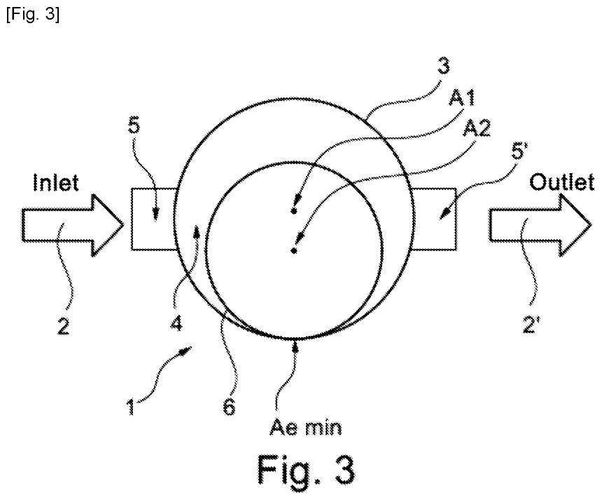

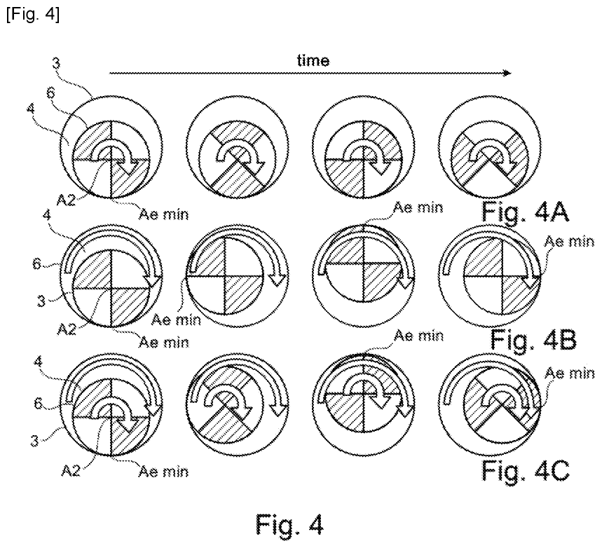

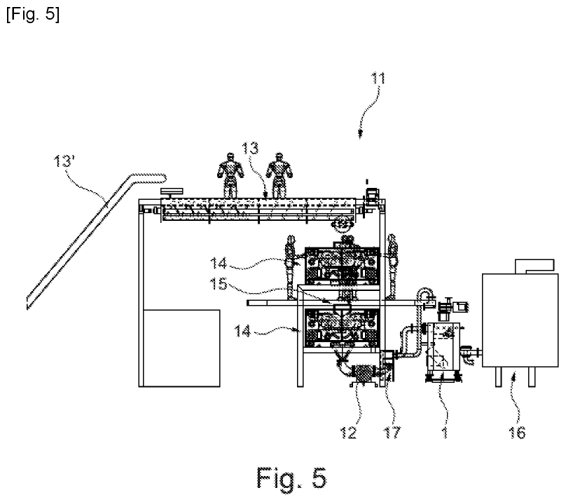

The invention will be more clearly understood from the description that follows, which relates to a preferred embodiment, provided as a non-limiting example, and explained with reference to the appended schematic drawings, in which:

[FIG. 1A], [FIG. 1B] and [FIG. 1C] are respectively elevation views from two different directions and a top view of a refiner according to the invention;

[FIG. 2A] and [FIG. 2B] are cross-sectional views, in a vertical plane containing the axis of symmetry of the outer enclosure, and in elevation and in perspective respectively, of a refiner as shown in FIG. 1 (at two different scales);

[FIG. 3] is a cross-sectional view in a plane perpendicular to the axis of symmetry of the enclosure and from above the refiner of FIG. 1;

[FIG. 4] shows, by means of FIGS. 4A to 4C, series of four views each showing a type of movement: simple (or elementary) movement (FIGS. 4A and 4B) or combined (or complex) movement (FIG. 4C), that can be made by the assembly [drum/enclosure] forming part of the refiner according to the invention; and

[FIG. 5] is a schematic representation, in elevation, of a treatment and upgrading installation according to the invention comprising at least one refiner as shown in FIGS. 1 and 2.

FIGS. 1 and 2 in particular show a refiner 1 for treating composite products 2 made from thermoplastic material(s), in particular polymeric and/or bituminous material(s), these products 2 being advantageously pretreated and in viscous form, and containing solid fragmentary and/or particulate elements, of mineral and/or organic nature(s), such as particles or fibers.

This refiner 1 comprises an enclosure 3 with a cylindrical wall, defining a treatment chamber 4 provided with at least one feed opening 5 for products 2 to be treated and at least one outlet opening 5′ for treated products 2′, and a cylindrical drum 6, mounted so as to be able to move in the cylindrical enclosure 3 and having a diameter smaller than that of the latter, the longitudinal axes of symmetry A1, A2 of the outer enclosure 3 and the inner drum 6 respectively being parallel to each other.

According to the invention, said refiner 1 comprises a means for heating the treatment chamber 4 and the drum 6 (cylindrical) is mounted in the outer enclosure 3 (cylindrical) so that it is able to move in rotation about its longitudinal axis A2 and so that its longitudinal axis A2 is able to move along a circular path around the longitudinal axis A1 of said enclosure 3, the two types of possible movements mentioned above being controlled by separate drive and/or actuation means 7, 8, allowing them to be effected selectively or in combination.

The combination in the refiner 1 of the synergistic effects of the heat and the absolute and relative movements of the drum 6 and the enclosure 3 (mechanical actions of crushing, shearing and mixing) allows an efficient and complete treatment of composite products of a thermoplastic nature (in particular as inputs in viscous form, in particular made from bitumen containing polymers and solid particles (in particular granules and fibers). Therefore, and by virtue of the abovementioned technical arrangements:

1) The macroscopic hard particles (>mm) are treated. They are sheared/ground between the wall of the cylinder (outer enclosure 3) and the wall of the drum 6. In the event of wear, the cost of replacing a cylinder/drum is relatively low (in particular less expensive than re-sharpening the blades of a colloidal mill). As a collateral effect, the hardest solid particles present in the composite product effect attrition on the softest particles.

2) Complete fragmentation of the granules and/or the fibers present takes place.

Granules and/or fibers are stretched and reduced in the gap e by the shearing between the wall of the drum 6 and the wall of the cylinder 3. Since this cylinder 3 is heated, the stretching is carried out at a controlled temperature which may be different from that of the input product. The temperature setpoint may be set higher than temperature thresholds of the material to be fragmented (e.g.: glass transition temperature Tg). Operating at higher than the Tg greatly assists the fragmentation of the material and the performance of the refiner 1.

In view of the structure of the refiner 1, the variable gape defined between the drum 6 and the enclosure 3 has a minimum value (along a longitudinal axis Ae min parallel to the axes A1 and A2) and thus determines the maximum degree of dimensional reduction of the solid particles/fragments present in the treated input and the degree of avoidance of the materials constituting the thermoplastic material of the treated composite product 2. This minimum gap is, depending on the type of movement of the drum 6, either fixed, or movable (see FIGS. 4A to 4C).

Advantageously, the longitudinal axes A1, A2 of the outer enclosure 3 and the inner drum 6 respectively are oriented substantially vertically, the drive means 7, and possibly the actuation means 8, being advantageously installed on the enclosure 3, at the top of the latter, for example on a cover opposite the bottom of the enclosure 3 and closing the latter at the top. Two separate reduction gear assemblies 8′, 8″ may form the actuation means 8, each associated with a specific movement transmitting/transforming means 7 (transmission, offsetting/movement of the axis of rotation, meshing, etc.).

Preferably, the feed opening 5 is provided at the bottom of the enclosure 3 and the outlet opening 5′ is provided at the top of the latter, these two openings 5 and 5′ being situated opposite each other with respect to the longitudinal axis A1 of the enclosure 3 and in a plane containing this axis (see FIGS. 2 and 3).

In accordance with one possible feature of the invention, allowing the refiner 1 to be calibrated and the properties of the treatment that it performs to be adjusted, said refiner 1 may comprise guide means, preferably present at the top and bottom of the enclosure 3 and providing the movement of the longitudinal axis A2 of the drum 6 along a circular path in the enclosure 3 around the longitudinal axis A1 of the latter, these means being advantageously configured to allow the gap e (in particular its minimum value) to be adjusted between the outer face of the drum 6 and the inner face of the enclosure 3.

According to another possible feature of the invention, the refiner may comprise a control means for controlling the two separate actuation means, suitable and intended to implement the two types of movements of the drum 6, with a view to their separate or combined control, said control means possibly forming part of a means for overall control and management of a treatment installation 11 incorporating said refiner 1.

The controlled injection of the products in viscous form is, for example, carried out by a circulation pump 12, adapted to the composite products to be treated, and connected to the feed opening 5 situated at the bottom of the enclosure 3. However, this injection may also be carried out by force of gravity from a heated temporary storage tank or from another upstream treatment station.

In order to be able to easily check the degree of treatment of the injected products and obtain practical and reliable information for controlling the injection of same, and the replenishing of the products in the chamber 4, the refiner 1 is advantageously provided with sensors for measuring the force(s) applied in order to move the drum 6 about its longitudinal axis A2 and/or in the enclosure 3. Temperature and possibly viscosity sensors may also be provided.

The refiner 1 has various adjustment possibilities, namely:
two parameters for adjusting the intensity of the mechanical work (shearing), namely: the speed of movement/rotation of the drum 6 (for example: speed of rotation on itself: 200 rpm/eccentric movement speed: 60 rpm) and the minimum value of the gap e (for example: 0.5 to 0.1 mm).
a parameter relating to the treatment time, i.e., the residence time of the products in the chamber 4 (for example 10 to 50 secs).

A certain number of practical structural arrangements that are possible in the context of the invention are described hereinafter with reference to the appended figures.

Therefore, the enclosure 3 advantageously consists of two shells or cylindrical tubular portions spaced apart by a gap to form a double casing in which a heat-transfer fluid circulates (thermal oil circulating between the two walls of the casing).

The materials which are used to produce said shells are special steels designed to withstand high temperatures, having good thermal conductivity, and being resistant to the abrasion of the material that is present and treated in the chamber 4. These choices give the heat exchange between the enclosure 3 and the material present in the working chamber 4 a high degree of efficiency. All the surfaces in contact with the material are re-machined after assembly by welding.

The drum 6 is, for example, constituted by a hollow cylinder machined from a pre-treated, abrasion-resistant steel. This drum 6 is assembled on a shaft defining the axis A2, this shaft being guided by two bearings and driven by a main reduction gear 8′.

A secondary reduction gear 8″ (forming, with 8′, the actuation means 8) drives the eccentricity unit that forms part of the movement transmitting/transforming means 7. This unit is, for example, essentially constituted by two ring gears 7′ and 7″ with balls or rollers for guiding and moving the drum 6, which are spaced apart and support plates with mechanisms for adjusting said eccentricity (see FIGS. 1 and 2 in particular).

A dynamic sealing device with double rotational movement is preferably provided in order to seal said material working chamber 4.

The invention also relates, as shown in FIG. 5, to an installation 11 for treating and upgrading composite products made from thermoplastic, for example waste incorporating mostly bituminous products, in particular bituminous membranes, this installation 11 comprising several successive treatment stations 13, 14, 15, 1.

This installation 11 is characterized in that it comprises, as a treatment station, at least one refiner 1 as described above, preferably as the last or penultimate treatment station.

The installation 11 may, for example, comprise (as the first station) at least one heating mixer 13, fed with composite products (possibly pretreated), for example bituminous construction and factory waste, conveyed by a conveyor 13′, for example.

The hot and viscous output from the mixer 13 passes through at least one, and preferably two, roller mill(s) 14 associated with a separator for separating macroscopic pollutants 15 (ejector/extractor device) before being transferred directly or indirectly into the refiner 1 by a pump 12. The output (treated products 2′) from the refiner 1 may be stored in a tank 16.

An additional treatment station 17 (filter, macerator, etc.) may possibly be installed before the refiner 1.

Finally, the invention also relates to a method for reducing the components of composite products made from thermoplastic material(s), in particular polymeric material(s), containing solid fragmentary and/or particulate elements, of mineral and/or organic nature, such as particles or fibers, by using a refiner 1 as described above.

This method is characterized in that it consists in injecting, into the enclosure 3 of the refiner 1, via its feed opening 5, composite products 2 to be treated, preferably pretreated and viscous, in a controlled manner, continuously or sequentially, treating these products in the enclosure 3 by heating and by continuously or intermittently moving the drum 6 in the enclosure 3, this movement being effected either in rotation about its longitudinal axis A2, or along a circular path around the longitudinal axis A1 of the enclosure 3 or indeed by combining the two abovementioned movements.

As previously indicated, control of the shearing may be envisaged, by adjusting the gap e between the drum 6 and the enclosure 3 and by determining the speed and the nature of the movement of the drum 6 in the enclosure 3.

In order to optimize the operation of the refiner 1 and, if required, to prevent it from possibly becoming jammed due to clogging, the method may consist, on a regular basis or following the detection of a resistant force greater than a threshold value, in at least temporarily inverting at least one of the two movements of the drum 6.

As a variant, or alternatively to a unidirectional movement, the method may also consist in moving the longitudinal axis A1 of the drum 6 around the longitudinal axis of the enclosure in an oscillating back-and-forth movement, centered on the feed opening 5, for example by about 100° to either side of said opening 5.

Naturally, the invention is not limited to the embodiment described and shown in the appended drawings. Modifications remain possible, in particular in terms of the constitution of the various elements or by substituting technical equivalents, without departing from the scope of protection of the invention.

1. A refiner for treating composite products made from thermoplastic material(s), in particular polymeric and/or bituminous material(s), these products being advantageously pretreated and in viscous form, and containing solid fragmentary and/or particulate elements, of mineral and/or organic nature(s), such as particles or fibers, said this-refiner comprising:
an enclosure with a cylindrical wall, defining a treatment chamber provided with at least one feed opening for products to be treated and at least one outlet opening for treated products, and a cylindrical drum, mounted so as to be able to move in the cylindrical enclosure and having a diameter smaller than that of the latter, the longitudinal axes of symmetry of the outer enclosure and the inner drum respectively being parallel to each other,
said refiner further comprising a means for heating the treatment chamber and in that the drum is mounted in the outer enclosure so that said drum is able to move in rotation about its longitudinal axis and so that its longitudinal axis is able to move along a circular path around the longitudinal axis of said enclosure, the two types of possible movements mentioned above being controlled by separate drive and/or actuation means, allowing them to be effected selectively or in combination.

2. The refiner as claimed in claim 1, wherein the longitudinal axes of the outer enclosure and the inner drum are oriented substantially vertically, the drive means, and possibly the actuation means, being advantageously installed on the enclosure, at the top of the latter.

3. The refiner as claimed in claim 1, wherein the feed opening is provided at the bottom of the enclosure and in that the outlet opening is provided at the top of the latter, these two openings being situated opposite each other with respect to the longitudinal axis of the enclosure and in a plane containing this axis.

4. The refiner as claimed in claim 1, wherein guide means, preferably present at the top and bottom of the enclosure, provide the movement of the longitudinal axis of drum along a circular path in the enclosure around the longitudinal axis de the latter, and are advantageously configured to allow the gap between the outer face of the drum and the inner face of the enclosure to be adjusted.

5. The refiner as claimed in claim 1, wherein said refiner comprises a control means for controlling the two separate actuation means, suitable and intended to implement the two types of movements of the drum, with a view to their separate or combined control, said control means configured to be able to from part of a means for overall control and management of a treatment installation incorporating said refiner.

6. The refiner as claimed in claim 1, wherein a circulation pump, adapted to the composite products to be treated, is connected to the feed opening situated at the bottom of the enclosure.

7. The refiner as claimed in claim 1, wherein said refiner is provided with sensors for measuring the force(s) applied in order to move the drum about its longitudinal axis and/or in the enclosure.

8. An installation for treating and upgrading composite products made from thermoplastic, for example waste incorporating mostly bituminous products, in particular bituminous membranes, said installation comprising:
several successive treatment stations, the installation having, as a treatment station, at least one refiner as claimed in claim 1.

9. A method for reducing the components of composite products made from thermoplastic material(s), in particular polymeric material(s), containing solid fragmentary and/or particulate elements, of mineral and/or organic nature, such as particles or fibers, by using the refiner as claimed in claim 1, comprising the steps of:
injecting, into the enclosure of the refiner, via its feed opening, composite products to be treated in a controlled manner, continuously or sequentially, treating these products in the enclosure by heating and by continuously or intermittently moving the drum in the enclosure, this movement being effected either in rotation about its longitudinal axis, or along a circular path around the longitudinal axis of the enclosure or indeed by combining the two abovementioned movements.

10. The method as claimed in claim 9, wherein said method further comprises the step of controlling the shearing by adjusting the gap between the drum and the enclosure and by determining the speed and the nature of the movement of the drum in the enclosure.

11. The method as claimed in claim 9, said method comprising, on a regular basis, or following the detection of a resistant force greater than a threshold value, at least temporarily inverting at least one of the two movements of the drum.

12. The method as claimed in claim 9, wherein said method further comprises moving the longitudinal axis of the drum around the longitudinal axis of the enclosure in an oscillating back-and-forth movement, centered on the feed opening.

13. The installation as claimed in claim 8, wherein said at least one refiner is either the last or penultimate treatment station.

14. The method as claimed in claim 12, wherein the moving of the longitudinal axis of the drum around the longitudinal axis of the enclosure in an oscillating back-and-forth movement, is centered on the feed opening by about 100° to either side of said opening.
